(19) United States
(12) Patent Application Publication
(10) Pub. No.: US 2011/0191703 A1
(43) Pub. Date: Aug. 4, 2011

(54) System and Method for Providing Customized and Localized User Interface

(75) Inventors: Michael James Doser, Rochester, NY (US); Jeffrey R. Bloom, Rochester, NY (US)

(73) Assignee: Fujifilm North America Corporation, Valhala, NY (US)

(21) Appl. No.: 13/119,474

(22) PCT Filed: Sep. 22, 2009
(86) PCT No.: PCT/US09/57833

§ 371 Date: Apr. 13, 2011

Related U.S. Application Data
(60) Provisional application No. 61/098,999, filed on Sep. 22, 2008.

(51) Int. Cl. G06F 3/048

(52) U.S. Cl. 715/763

(57) ABSTRACT

A system and method for providing text-file-based design and runtime dynamic user interface for software applications. The present invention provides one or more text based file format such as an XML file for capturing and storing localization data specifications for user interface screens—translation keys, one or more text based file format for providing language or locality specific translations—localization data, a software module to integrate a user interface design tool to provide runtime and design time translation services, a data processing framework library to support the creation of the localization data, and a run-time mode that provides translation by utilizing lookups of translation keys against a set of localization data files.

### CROSS-REFERENCE TO RELATED APPLICATIONS

This application claims the benefit of U.S. Patent Application No. 61/098,999, filed Sep. 22, 2008.

### FIELD OF THE INVENTION

The present invention generally relates to a system and method for providing customized and localized user screen interfaces that adapt to the regional language(s) of an installation location. The present invention relates to providing localization data in a format that can be easily utilized and also manipulated by users with no programming background in order to customize screens. Such users are able to create localized interface screens that enable objects to be displayed with values from multiple locales on a single user interface screen.

### BACKGROUND OF THE INVENTION

The wide spread use of computing devices and application programs creates a need for developers and applications to address contextual differences among end users. In other words, devices and application programs should be designed to accommodate and handle a variety of styles, languages, information and representations for a multitude of interactive end users. Generally, most systems and designers accomplish this requirement by customizing at least the user interface portion of the application for the different environments or locales, where the application will be used. While the business logic or other algorithms remain the same, multiple copies or formats of front-end applications or at least the visible user screens are created for each locale. Such an approach obviously creates a myriad of problems, not the least of which is keeping track of the various versions of the programs or having to recompile multiple versions when a change or update is required. To overcome this short coming, the concepts of application internationalization and localization have evolved within the computing industry. Internationalization refers to the process of designing a software application so that it can be adapted to various languages and regions without engineering changes. Localization refers to the process of adapting software for a specific region or language by adding locale-specific components and translating text. These terms are used herein interchangeably unless otherwise indicated.

The present invention is generally directed to the localization of interactive user or application environments. More specifically, the invention is directed to a process and tool for providing configuration, processing and implementation of localized user interfaces by use of a data driven methodology utilizing data outside of the hosting application. One area of implementation for the present invention is in the area of digital photography and printing.

Digital photo image processing is a rapidly growing technology area. Digital cameras are in wide use today and a user has many options as to how the digital images are converted to a photograph or used in and on other products. For example, users may simply download images from a digital camera to a computing device for direct printing or to a personal computer where the user may edit or otherwise modify the image as desired. Another currently available option is to physically deliver or send the digital images electronically to a photofinisher or Kiosk that will print the desired photos or imprint the images onto other products for the user.

The computing device utilized by a user for this transposition of images, whether it is a personal system or a device located at retail or other location, presents an interface screen to the user either via a locally executed application program or a web based application. Such interface screen should be ideally designed to the regional or preferred language of the user. Current systems and methods have attempted to address this requirement by providing a variety of localization schemes, which have several drawbacks. One such popular scheme is provided by Microsoft Corporation and is known as the “LocBAML” method. As with many of the other existing localization schemes, LocBAML requires a complex development and maintenance process, and the use of sophisticated tools. This and other prior art methods require the presence and use, of development tools for maintenance. They may also require that the localization data be compiled into a binary format and compiled into the consuming application. This process is cumbersome, inefficient and inflexible. The process requires a significant amount of time to make the desired modifications and edits to screen interfaces, and more importantly limits the ability of non-programmers or system administrators to modify or enhance their user interface.

What is needed is a robust, efficient and user-friendly tool and technique for providing application user interfaces that are adaptable to the regional language of the installation and does not constrain the providers or support personnel of the application. In other words, a localization system and methodology wherein:
a. Localization data may be stored in human readable text file format, such that translations may be performed by individuals with no knowledge or access to software development tools;
b. Localization data may be updated using a no-cost tool such as a simple text editor;
c. The localization software module is accessible to user interface designers using a wide variety of development tools without the need for a compiler tool to operate;
d. Training costs and development license costs are minimized;
e. Localized values from multiple locales may be simultaneously utilized in a single user interface screen; and
f. Localization content is reusable across various areas of an application without the need for redundant data.

The present invention fills these needs as well as other needs.

### SUMMARY OF THE INVENTION

In order to overcome the above stated problems, the present invention provides a text-file based localization scheme for design and run-time dynamic user interface localization of software applications. The invention comprises the steps of: providing a text-based file format for capturing and storing localization data specifications for objects on user interface screens referred to as a translation key; a text-based file format for supplying language or locality specific translations based on the translation key referred to as the localization data format or meta-data; a software module to interface with a user interface design tool and/or application development tool to provide translation services; a data processing framework library providing support/tools to create said language and locality specific localization data entries using said translation key; and further providing support/tools to supply language translations using lookups of translation keys against a set of localization data entries.

In one particular aspect, the present invention includes a method programmed in a computing environment for providing dynamic localization of a user interface, wherein the user interface includes one or more user interface objects. The method comprises: providing an interface module to a user interface design tool and/or application development tool, wherein the user interface design tool and/or application development tool is utilized to specify the one or more user interface objects; the interface module providing a record comprising a translation key and a value field, for zero or more of the one or more user interface objects, for storage in a translation key file; the value field specifying a user viewable text label for the associated record of the one or more user interface objects; processing the translation key file to provide a text-based localization file for storing one or more localization data specifications associated with the one or more user interface objects, the one or more localization data specifications including the value field; providing language or locality specific translations of the value field to a localized value; and utilizing a software module to employ the text-based localization file to thereby display the localized value for the associated one or more user interface objects.

In another aspect, the present invention includes a method programmed in a computing environment for providing localization of a user interface having one or more user interface objects each having a display label. The method comprises: providing data driven localization for the one or more user interface objects by employing a translation key file and a localization file; providing language or locality specific translations of the translation key file to specify the localization file; and employing a software module adapted to operate in a first mode for identifying context and selecting at least one of the one or more user interface objects that are to be localized in the translation key file, and the software module adapted to operate in a second mode for providing localization of the selected user interface objects. The operation of the software module in the first mode provides an interface to a development tool to provide in the translation key file, a context, a key and a value. The context specifying a screen area to be localized, the key identifying the selected user interface objects to be localized, and the value providing a default label for the display of the selected user interface objects. The value in the translation key file is translated to a localized value in the localization file. The operation in said second mode interfaces with the user interface to acquire from the localization file, the context, the key and the translated localized value, wherein the selected user interface objects may be displayed with the localized value as the display label.

In another aspect, the present invention includes a computing system for providing dynamic localization of a user interface, wherein the user interface includes one or more user interface objects. The system comprises a translation key file comprising a context, a key, and a value. The system also includes a localization file comprising the context, the key, and a localized value. The system further includes a localization application and a data processing software module. The translation key file identifies the context and particular one or more interface objects to be localized. The context specifies a screen area on the user interface, the key identifies the particular one of the interface objects to be localized, and the value provides a default label for the particular one of the interface objects. The localization application is programmed to translate the value in the translation key file into the localized value in the localization file for the particular one of the interface objects. The data processing software module is programmed to provide data to populate the translation key file and to look up the localization file to provide localization of the one or more user interface objects.

Additional benefits of the above described system and method for providing localized user interface screens are set forth in the following discussion.

### BRIEF DESCRIPTION OF THE DRAWINGS

The above-mentioned and other features and advantages of this invention, and the manner of attaining them, will become apparent and be better understood by reference to the following description of the invention in conjunction with the accompanying drawing, wherein:

FIG. 1 generally illustrates a networking environment in which the present invention may be used;

FIG. 2 is a block diagram generally illustrating the system of the present invention and components thereof;

FIG. 3 is a block diagram generally illustrating the function of the data processing framework of the present invention; and

FIG. 4 is a block diagram generally illustrating a computing environment in which the invention may be implemented.

### DETAILED DESCRIPTION OF THE INVENTION

Generally, the tools and methods described herein for creating and implementing localization of user interfaces can be implemented in software.

This document is organized as follows. In the first section, an overview of the techniques and implementation is provided and described. In the next section, an exemplary system to which the present invention would be applicable, specifically a photo ordering process is discussed. Following this, the process for developing a user interface and the associated file types is discussed, along with the operational function of the present invention. Finally, an exemplary computer environment for the implementation and use of the invention is described.

Overview of Techniques and Implementations

The invention can be thought of in the context of a workflow, involving the processes of providing a text-based file format for capturing and storing localization data specifications for objects that are located on user interface screens referred to as a translation key; a text-based file format for supplying language or locality specific translations based on the localization data specifications referred to as a localization data file; a software module to interface with a user interface design tool and/or application development tool to provide translation services; a data processing framework (e.g., application) to create said language and locality specific translations using said translation key; and a run-time data processing framework library that supplies language translations using lookups of translation keys against a set of localization data entries. In order to facilitate an understanding of the invention and the novel features, the invention is described herein in the context of a photo ordering and fulfillment process.

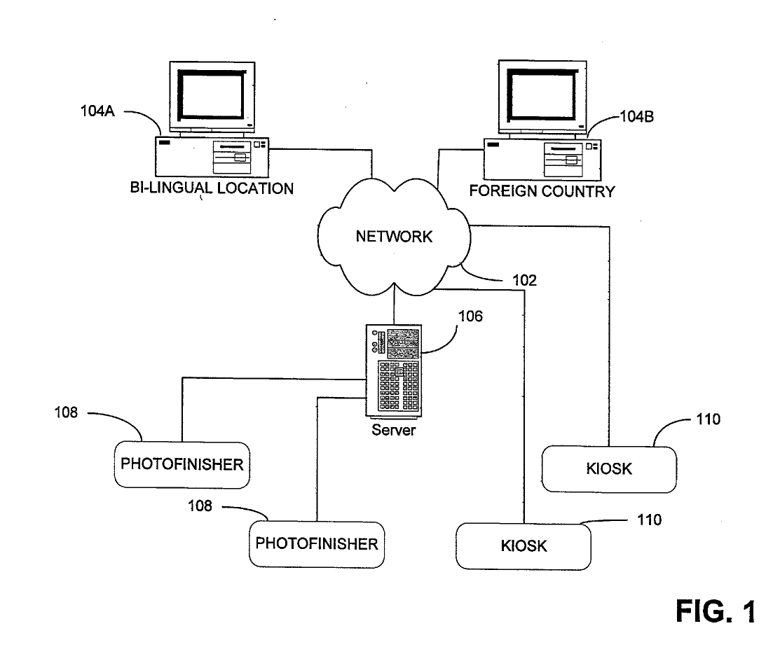

With reference to the drawings, an exemplary environment or system to which the present invention would be applicable is shown in FIG. 1 and is designated as reference numeral 100. The system 100 may include a network 102, such as a Local Area Network (LAN), Wide Area Network (WAN), Wireless network or other similar configuration for allowing communication among two or more computing devices. Connected to the network 102 may be general purpose computing devices 104A, 104B, generally referenced as computing device 104. Computing device 104A may be a personal computer located in a home, office, retail location or other environment, in which it is required that the user interface support multilingual information display, depending on end-user selection or other selection criteria. Computing device 104E may be a device located in a foreign country where it is necessary to have the user interface in a foreign language. A server 106 may also be connected to the network 102 to provide any one or more of a variety of functions including being a Web Server, data storage, application server and/or provide other services. One or more photofinishers 108 and Kiosks 110, or other devices may also be remotely located and connected to the network 102. In general, the present invention relates to providing on the computing devices 104, a user interface that is localized for an end user, thus enabling interaction with an underlying application(s), in a language or context that is familiar. An example of such a use might be to enable the user, using remote computing device 104 to order a print of at least one digitally represented image from photofinishers 108 or Kiosk 110. The end user may provide a data file or other representation of a digitally represented image, select a print format for the digitally represented image, establish a print order that includes a print format, and optionally save the print order on the computing device 104 or a type of removable memory storage or media (e.g., CD, floppy disk, flash drive, etc). The print order data file may be uploaded or otherwise communicated to at least one of photofinishers 108 and Kiosk 110 via the network 102, or by physically taking the removable storage media to the photofinisher 14 or Kiosk 16 to place the print order. Thereafter, the photofinisher 14 or Kiosk 16 processes and delivers the print of the digitally represented image to the user or to a third-party designated by the user in accordance with the user defined delivery criteria.

In order to enable the above described process, an underlying application needs to present instructions, options and interaction with the user and the user will need to make selections and/or provide preferences via a user interface of the computing device 104. This requires that user interface screens or other methods of interaction with the user be localized. That is to say that presentation of instructions or other relevant information needs to be in a language and/or context that are familiar to the user or relevant to the locale where computing device 104 is located. As such, a designer of the user interface needs to localize the application and more specifically, the user interface. The present invention provides means for a designer and means for an application program, to present a localized user interface across multiple computing devices 104 in different locales. Even further, the present invention provides means for designing and presenting on a single computing device 104, multiple localizations. Further still, the present invention provides means for designing and presenting individually localized objects on a single user interface screen. Importantly, the present invention provides localization through a data driven methodology that enables configuration and implementation of localized interfaces. For example, continuing with the order placement system earlier described, a screen or portion thereof may need to present bi-lingual textual data and buttons.

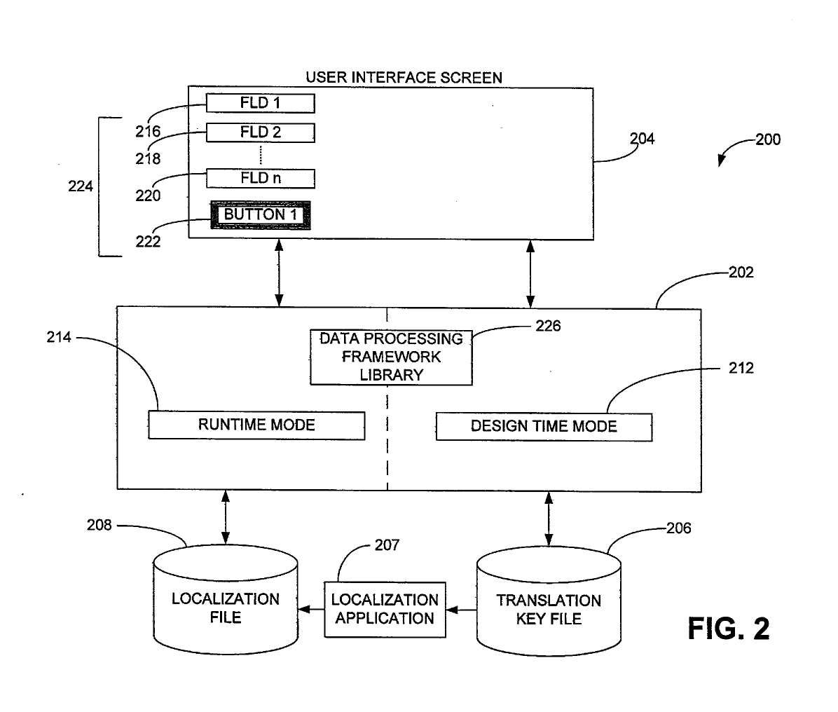

The design and presentation of such a user interface screen in accordance with the present invention, is best described with reference to the illustrated system of FIG. 2, designated as reference numeral 200. System 200 includes a software module 202, a data processing framework library 226, user interface screen 204, a translation key file 206, and a localization file 208. The software module 202 is operable in a runtime mode 214 and a design time mode 212 utilizing the data processing framework library 226. The functionality associated with system 200 may be conceptualized as having two categories. In a first category, system 200 generally presents functionality for designing user interfaces and for defining, organizing and generating language translation related information. In a second category, system 200 presents functionality for executing and presenting localized objects on the user interface screen 204 to end-users. The categories or mode of operation of the system 200 are determined by the functions provided by the software module 202.

In one aspect of the present invention, the software module 202 may operate in a design time mode 212 or a runtime mode 214. In the preferred embodiment of the present invention, the software module 202 detects when it is in design time mode 212, by checking for the presence of a uniquely identified operating system object, the absence of which signals a runtime mode 214.

### Exemplary System Implementation

The software module 202 may be implemented with a product such as Windows Presentation Foundation (WPF) eXtensible Application Markup Language (XAML) markup extension produced by Microsoft Corporation of Redmond, Wash. XAML markup extension is a tool that allows software developers to integrate custom code into the process of building a WPF user interface screen from an XAML file. XAML markup extensions accept input in the form of name/value pairs of strings, and return a string value.

User interface screen 204 may be produced by the interactive editing of a XAML file by a screen designer. Essentially, the designer, utilizing a tool such as Microsoft Blend, or a software developer using a tool such as Microsoft Visual Studio, both produced by Microsoft Corporation of Redmond, Wash., can interactively edit a XAML file and see a graphical representation of the resulting screen.

In operation, when the software module 202 is operating in the design mode 212, it participates in the interactive editing process of the XAML file for the user interface screen 204. Objects added to the screen interface 204 are correlated to the translation key file 206. In one aspect of the present invention, when a designer provides a key that is not present in the underlying translation key file 206, the software module 202 updates the translation key file 206 by adding the new key. This feature enables designers and developers to specify translation keys and build the translation key file 206, during design activities, without leaving the design environment.

In designing the user interface screen 204, a designer may specify any number of screen objects 224 comprising of text fields, graphical objects, buttons, data entry fields and other types of objects supported by the development environment. These screen objects 224 may be located in different regions of the screen and are created by utilizing an appropriate design or development tool, such as those identified earlier in this document. To illustrate, the screen 204 is shown with a design that includes Fld1 216, Fld2 218, Fldn 220, and Button1 222, collectively referenced as screen objects 224.

As each of the objects 224 is defined by the designer, an appropriate key for each object is either located within the translation key file 206 or newly created. Table 1 provides an exemplary illustration of data items that would be found in a structure for the translation key file 206, for the user interface screen 204. As would be appreciated by one skilled in the art, the format and syntax for specifying entries in the translation file may be varied and still remain within the scope of the present invention. The tabular representations of the tables utilized in this document are presented solely for ease of visual presentation and discussion.

TABLE 1

| | | | Max | | Localization |
|---|---|---|---|---|---|
| Context | Key | Value | Length | Type | Note |
| Screenx | Fld1 | Name | 15 | Text | Prompt for Name |
| | | | | | of the user |
| screenx | Fld2 | City | 30 | Text | Prompt for City |
| | | | | | of residence |
| screenx | Button1 | Yes | 5 | Text | Label to indicate |
| | | | | | affirmation |

The translation key file 206 supports user interface design activities by storing metadata for each translation key element. A Context element provides and identifies a screen or major area of the screen that is to be localized. A key element identifies the particular element or object 224 that is to be localized within the Context. A Value element provides a default translation value for designers to use to visualize screen objects during the design process. The Value element becomes the initial localized value used by a Translation Service Provider (TSP). A TSP may be a third party or in some instances a linguist who can provide appropriate translation as required. A LocalizationNote element provides a catch-all field to store any further notes about an individual translation key. For example, the TSP can view the note to aide in providing an accurate translation of the Value element. MaxLength element is an integer value representing the maximum number of characters that a translated value may have. Type element, is a string value that may be used to store the type of data that the translation key represents (i.e. text, graphic, etc), as determined by the consuming application.

Viewing the user interface screen 204 in conjunction with Table 1, the correlation between the screen objects 224 and the entries of the translation can be recognized. Each of the objects 224 has a representative entry in the translation key file 206. Specifically, and as shown, the entire screen or the region of the screen where the objects 224 are located may be identified as ‘screenx’. Accordingly, a Context element entry of ‘screenx’ is provided for each of the object entries in the translation key file 206. Fid1 216 is identified with a Key element of “Fld1”, having an initial translation value of “Name”, a maximum translation length of “15”, a type of “Text” and Localization Note of “Prompt for Name of the user”. Similarly, Fld2 218 and Button1 are also defined in the translation key file 206. It should be noted that Fldn 220 has no entry in the translation key file 206. This could be one method of indicating that Fldn 220 is not an object for which a translation is desired. Alternatively and as would be appreciated by one skilled in the art, an entry could be made into the translation key file 206 with either a null entry for the Value field, or an entry of some predefined constant indicative of the fact that no translation is required.

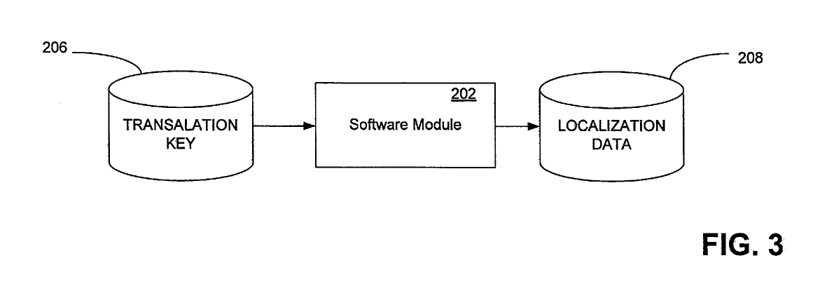

When the design of the user interface screen 204 is completed or as entries are specified within the translation key file 206, further processing is performed by the system 200 to operate on the translation key file 206 and the entries therein. More specifically, a localization application 207 may be utilized to operate on the translation key file 206 to produce the localization data file 208. Alternatively, a user in a manual process could directly edit the translation key file 206 to provide translations and save the file as a localization file 208. Such a user might employ an XML editor, notepad or other text-based editor. In another alternative, and as shown in FIG. 3, the software module 202 may create the localization file 208 with default/non-translated values. An exemplary illustration of data items for the localization data file 208 is shown in Tables 2A and 2B. The localization data file 208, when first created in the manner described, would not reflect translations of the Value fields.

In operation, the localization data file 208 is distributed to linguists or TSPs to provide appropriate translation data. Importantly, the linguists may utilize any text editing tool to edit the translation data file 208. In the described embodiment of the present invention, such a text-editing tool is one that is capable of updating XML files. In a further aspect of the invention, hierarchical name spaces, known in the art as “contexts” are supplied along with the translation key so that appropriate translations for the specific area of a the user interface screen 204 may be supplied. It should be noted that while a particular application software program may have multiple local translation data files 208 each of which may be associated with an individual screen, a single user interface screen may also have multiple local translation data files 208, which may be associated with regions of the screen or associated with specific translations, such as different languages, as shown in the tables.

An exemplary illustration of one structure for a localization data file 208 that may be associated with user interface screen 204 is shown in Table 2A.

TABLE 2A

| CultureName | Context | Key | Value |
|---|---|---|---|
| es-MX | screenx | Fld1 | Nombre |
| es-MX | screenx | Fid2 | Ciudad |
| es-MX | screenx | Button1 | Si |

Table 2A illustrates a localization data file 208, wherein a linguist has provided translations for each of the Keys, for a Spanish based locale. A similar localization data file 208 may also be provided for a French based locale such as illustrated in Table 2B.

TABLE 2B

| CultureName | Context | Key | Value |
|---|---|---|---|
| fr-FR | screenx | Fld1 | Nom |
| fr-FR | screenx | Fld2 | Ville |
| fr-FR | screenx | Buton1 | Oui |

As previously described, the localization files 208 shown in Table 2A and Table 2B may reside on the same computing device 104, particularly if the computing device 104 is intended to have multi-lingual localization. In other words, either by end user selection or otherwise, the screen objects would be displayed in Spanish or French, depending on the localization file in use. Further still, the contents of Table 2A and Table 2B may be combined into a single localization file, wherein locale is included as an entry within the file. Such a combination is shown in Table 3. One skilled in the art would appreciate that other configurations, structures and methods for providing the translation information may be implemented and that such implementations are anticipated and within the scope of the present invention.

TABLE 3

| CultureName | Context | Key | Value |
|---|---|---|---|
| es-MX | screenx | Fld1 | Nombre |
| es-MX | screenx | Fld2 | Ciudad |
| es-MX | screenx | Button1 | Si |
| fr-FR | screenx | Fld1 | Nom |
| fr-FR | screenx | Fld2 | Ville |
| fr-FR | screenx | Buton1 | Oui |

The produced localization data file(s) 208 includes all data necessary to support the runtime mode 214 of the software module 202. When application program including the user interface screen is deployed to an end-user computing device 104, the localization file(s) 208 are also deployed, along with the data processing framework library 226. In this environment, the software module 202 is intended to execute in the runtime mode 214.

In the runtime mode 214, the data processing framework library 226, is utilized to access localization information stored in the localization data file 208 to retrieve matching translated values for the user interface screen 204 objects 224. In one embodiment of the present invention, this operation is accomplished by utilizing inputs for locale, the context of the translation key, and the translation key itself to locate a matching localization data file 208.

The localization file 208 may be identified by a predetermined naming convention, wherein for example the localization file 208 has an identical filename to the context of the translations which is typically the user interface screen 204 name, followed by the culture code of the translations within the localization file 208. Irrespective of the mode of identification, once a localization data file 208 is identified the specific entries therein are matched to the Context and Key Values of the screen to provide translations and thus a localized user interface.

Having described the system and method of the present invention and an embodiment thereof, an exemplary computer environment for implementing the described design and execution is presented next.

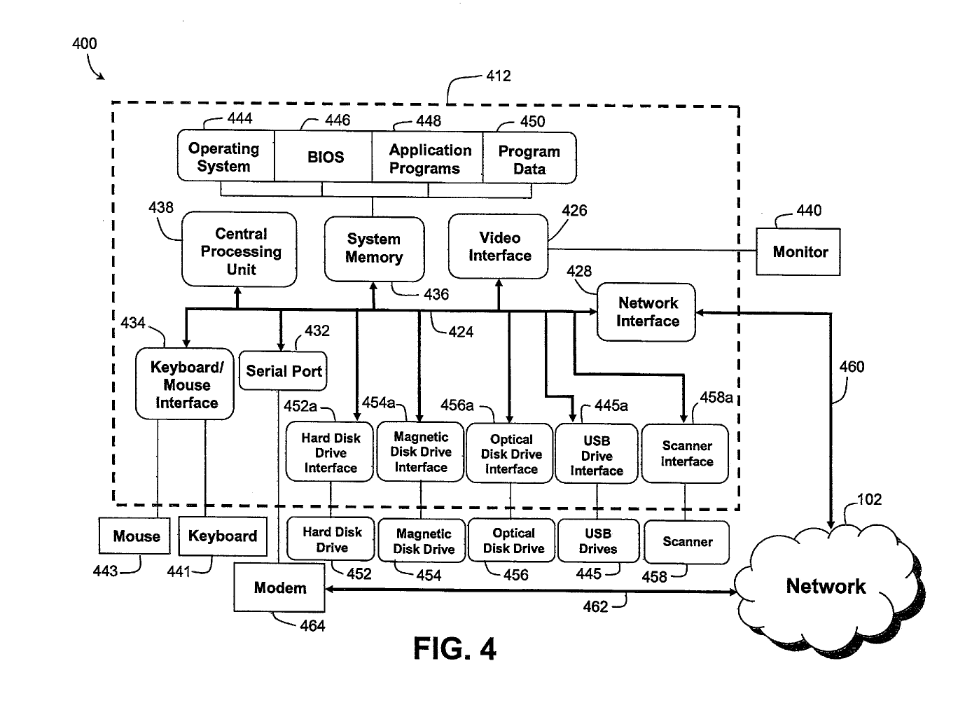

FIG. 4 illustrates an exemplary computing environment 400 that can be used to implement any of the processing thus far described. As shown, the computing environment 400 may comprise a computer 412 including a system bus 424 that couples a video interface 426, network interface 428, one or more serial ports 432, a keyboard/mouse interface 434, and a system memory 436 to a Central Processing Unit (CPU) 438. A monitor or display 440 is connected to bus 424 by video interface 426 and provides the user with a graphical user interface to view, edit, and prepare a print order data file using the digitally represented still images. The graphical user interface allows the user to enter commands and information into computer 412 using a keyboard 441 and a user interface selection device 443, such as a mouse or other pointing device. Keyboard 441 and user interface selection device are connected to bus 424 through keyboard/mouse interface 434. The display 440 and user interface selection device 443 are used in combination to form the graphical user interface which allows the user to implement at least a portion of the present invention. Other peripheral devices may be connected to computer 412 through serial port 432 or universal serial bus (USB) drives 445 to transfer information to and from computer 412. For example, cameras and camcorders may be connected to computer 412 through serial port 432 or USB drives 445 so that data representative of a digitally represented still image or video may be downloaded to system memory 436 or another memory storage device associated with computer 412 so that the images may be subsequently printed by photofinisher 108 or Kiosk 110 in accordance with the present invention.

The system memory 436 is also connected to bus 424 and may include read only memory (ROM), random access memory (RAM), an operating system 444, a basic input/output system (BIOS) 446, application programs 448 and program data 450. The computer 412 may further include a hard disk drive 452 for reading from and writing to a hard disk, a magnetic disk drive 454 for reading from and writing to a removable magnetic disk (e.g., floppy disk), and an optical disk drive 456 for reading from and writing to a removable optical disk (e.g., CD ROM or other optical media). The computer 412 may also include USB drives 445 and other types of drives for reading from and writing to flash memory devices (e.g., compact flash, memory stick/PRO and DUO, SD card, multimedia card, smart media xD card), and a scanner 450 for scanning items such as still image photographs to be downloaded to computer 412. A hard disk interface 452a, magnetic disk drive interface 454a, a optical drive interface 456a, a USB drive interface 445a, and a scanner interface 458a operate to connect bus 424 to hard disk drive 452, magnetic disk drive 454, optical disk drive 456, USB drive 445 and a scanner 458, respectively. Each of these drive components and their associated computer-readable media may provide computer 412 with non-volatile storage of computer-readable instruction, program modules, data structures, application programs, an operating system, and other data for the computer 412. In addition, it will be understood that computer 412 may also utilize other types of computer-readable media in addition to those types set forth herein, such as digital video disks, random access memory, read only memory, other types of flash memory cards, magnetic cassettes, and the like.

Computer 412 may operate in a networked environment using logical connections with photofinisher 108 and Kiosk 110. Network interface 428 provides a communication path 460 between bus 424 and network 102, which allows a print order data file to be communicated through network 102 to photofinisher 108 after the print order data file has been established, and optionally saved in a memory, using computer 412. This type of logical network connection is commonly used in conjunction with a local area network (LAN). The print order data file may also be communicated from bus 424 through a communication path 462 to network 102 using serial port 432 and a modem 464. Using a modem connection between the computer 412 and photofinisher 108 is commonly used in conjunction with a wide area network (WAN). It will be appreciated that the network connections shown herein are merely exemplary, and it is within the scope of the present invention to use other types of network connections between computer 412 and photofinisher 108 including both wired and wireless connections.

From the foregoing, it will be seen that this invention is one well adapted to attain all the ends and objects hereinabove set forth together with other advantages which are obvious and which are inherent to the method and apparatus. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. As used herein, the terms “having” and/or “including” and other terms of inclusion are terms indicative of inclusion rather than requirement.

While the invention has been described with reference to preferred embodiments, it will be understood by those skilled in the art that various changes may be made and equivalents may be substituted for elements thereof to adapt to particular situations without departing from the scope of the invention. Therefore, it is intended that the invention not be limited to the particular embodiments disclosed as the best mode contemplated for carrying out this invention, but that the invention will include all embodiments falling within the scope and spirit of the appended claims.

What is claimed is:

1. A method programmed in a computing environment for providing dynamic localization of a user interface, wherein said user interface includes one or more user interface objects, the method comprising:
providing an interface module to a user interface design tool and/or application development tool, wherein said user interface design tool and/or application development tool is utilized to specify the one or more user interface objects;
said interface module providing a record comprising a translation key and a value field, for zero or more of said one or more user interface objects, for storage in a translation key file;
said value field specifying a user viewable text label for the associated record of the one or more user interface objects;
processing said translation key file to provide a text-based localization file for storing one or more localization data specifications associated with the one or more user interface objects, said one or more localization data specifications including said value field;
providing language or locality specific translations of said value field to a localized value; and
utilizing a software module to employ said text-based localization file to thereby display said localized value for the associated one or more user interface objects.

2. The method of claim 1 wherein said translation is provided without leaving the design and/or application development environment.

3. The method of claim 1 further comprising, providing in said translation key file and said text-based localization file, a context element to identify a first screen area that is to be localized.

4. The method of claim 3 further comprising, providing in said translation key The and said text-based localization file, a second context element to identify a second area that is to be localized, whereby more than one localization representation may be presented in the user interface.

5. The method of claim 1, wherein said translation key file is a text-based file.

6. A method programmed in a computing environment for providing localization of a user interface having one or more user interface objects each having a display label, the method comprising:
providing data driven localization for the one or more user interface objects by employing a translation key file and a localization file;
providing language or locality specific translations of said translation key file to specify said localization file; and
employing a software module adapted to operate in a first mode for identifying context and selecting at least one of the one or more user interface objects that are to be localized in said translation key file, and said software module adapted to operate in a second mode for providing localization of the selected user interface objects;
wherein operation of said software module in said first mode provides an interface to a development tool to provide in said translation key file, a context, a key and a value, said context specifying a first screen area to be localized, said key identifying the selected user interface objects to be localized and said value providing a default label for the display of the selected user interface objects;
wherein said value in said translation key file is translated to a localized value in said localization file; and
wherein the operation in said second mode interfaces with the user interface to acquire from said localization file, said context, said key and said translated localized value;
wherein said selected user interface objects are displayed with said localized value as the display label.

7. The method of claim 6 wherein said second mode of operation provides for dynamic localization of said one or more user interface objects wherein changes to said localization file are reflected in realtime.

8. The method of claim 6 wherein more than one localization representation may be presented in said user interface.

9. A computing system for providing dynamic localization of a user interface, wherein said user interface includes one or more user interface objects, comprising:
a translation key file comprising a context, a key, and a value;
a localization file comprising said context, said key, and a localized value;
a localization application; and
a data processing software module;
said translation key file identifying said context and particular one or more interface objects to be localized, wherein said context specifies a first screen area on the user interface, said key identifies said particular one of the interface objects to be localized, and said value provides a default label for said particular one of the interface objects;
said localization application programmed to translate said value in said translation key file into said localized value in said localization file for said particular one of the interface objects;
said data processing software module programmed to provide data to populate said translation key file and to look up said localization file to provide localization of the one or more user interface objects.

10. A computer readable medium having computer executable instructions to implement a method for providing dynamic localization of a user interface, wherein said user interface includes one or more user interface objects, the method comprising:
providing an interface module to a user interface design tool and/or application development tool, wherein said user interface design tool and/or application development tool is utilized to specify the one or more user interface objects;
said interface module providing a record having a translation key and a value field, for zero or more of said one or more user interface objects, for storage in a translation key file;
said value field specifying a user viewable text label for said associated record of the one or more user interface objects;
processing said translation key file to provide a text-based localization file for storing one or more localization data specifications associated with the one or more user interface objects, said one or more localization data specifications including said value field;
providing language or locality specific translations of said value field to a localized value; and
utilizing a software module to employ said text-based localization file to thereby display said localized value for the associated one or more user interface objects.

11. The method of claim 4 wherein said first area and said second area are displayed on said user interface at the same time.

12. The method of claim 1 wherein said software module provides for dynamic localization of the one or more user interface objects wherein changes to said text-based localization file are reflected in realtime.

13. The method of claim 1 wherein said software module is implemented with Windows Presentation Foundation.

14. The method of claim 1 wherein said software module is implemented with Windows Presentation Foundation eXtensible Application Markup Language markup extension.

15. The method of claim 6 further comprising, providing in said translation key file and said localization file, a second context element specifying a second screen area to be localized, whereby more than one localization representation may be presented in the user interface.

16. The method of claim 15 wherein said first screen area and said second screen area are displayed on the user interface at the same time.

17. The method of claim 6 wherein said software module is in said first mode when said software module detects a uniquely identified operating system object.

18. The method of claim 17 wherein said software module is in said second mode when said software module does not detect said uniquely identified operating system object.

19. The method of claim 6 wherein said software module is implemented with Windows Presentation Foundation.

20. The method of claim 6 wherein said software module is implemented with Windows Presentation Foundation eXtensible Application Markup Language markup extension.

21. The computing system of claim 9 wherein said translation key file and said localization file include a second context element to identify a second screen area that is to be localized, whereby more than one localization representation may be presented in said user interface.

22. The computing system of claim 21 wherein said first screen area and said second screen area are displayed on said user interface at the same time.

23. The computing system of claim 9 wherein said data processing software module provides dynamic localization of the one or more user interface objects wherein changes to said localization file are reflected in realtime.

24. The computing system of claim 9 wherein said data processing software module is implemented with Windows Presentation Foundation.

25. The computing system of claim 9 wherein said data processing software module is implemented with Windows Presentation Foundation eXtensible Application Markup Language markup extension.

26. The computer readable medium of claim 10 further comprising, providing in said translation key file and said text-based localization file, a context element to identify a first screen area that is to be localized.

27. The computer readable medium of claim 26 wherein said translation key file and said text-based localization file include a second context element to identify a second screen area that is to be localized, whereby more than one localization representation may be presented in said user interface.

28. The computer readable medium of claim 27 wherein said first screen area and said second screen area are displayed on said user interface at the same time.

29. The computer readable medium of claim 10 wherein said software module provides dynamic localization of the one or more user interface objects wherein changes to said text-based localization file are reflected in realtime.

30. The computer readable medium of claim 10 wherein said software module is implemented with Windows Presentation Foundation.

31. The computer readable medium of claim 10 wherein said software module is implemented with Windows Presentation Foundation eXtensible Application Markup Language markup extension.
